(19) United States
(12) Patent Application Publication
(10) Pub. No.: US 2009/0000975 A1
(43) Pub. Date: Jan. 1, 2009

(54) FILE ORGANIZER WITH MULTIPLE DIVIDERS

(75) Inventor: David A. Schenker, Cedarburg, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: INNOVATIVE STORAGE DESIGNS, INC., Mequon, WI (US)

(21) Appl. No.: 11/769,246

(22) Filed: Jun. 27, 2007

(51) Int. Cl. B42F 15/00; B65D 85/00

(52) U.S. Cl. 206/425

(57) ABSTRACT

A file organizer that includes an open storage cavity for storing a series of hanging file folders. The storage body includes a file support edge upon which hanging file folders are supported. A peripheral flange is joined to the outer wall of the storage body and extends around the periphery of the storage body to define a receiving cavity. The file organizer includes a series of file dividers that each include a pair of ears extending from a main body of the file divider and a pair of feet located near the bottom edge of the main body. The storage body includes a first series of alignment tabs and a second series of alignment tabs that restrict the lateral movement of the file dividers within the open storage cavity such that the file dividers define compartments within the open storage cavity.

### BACKGROUND OF THE INVENTION

The present invention generally relates to a file organizer for hanging file folders. More specifically, the present invention relates to a file organizer that includes a series of dividers that can be positioned in selected locations to define compartments within the open storage cavity of the file organizer.

Presently, storage containers are known that are designed to allow a series of hanging file folders to be supported within a container body. The storage containers may or may not include a lid to enclose the container to prevent dirt, debris or moisture from entering into the storage container and damaging the material within the file folders.

Although containers are known that support hanging file folders, most of these devices include a hollow, open cavity that does not include any type of divider system to create file compartments for categorizing file folders where the dividers are securely held in selected positions. Instead, many file containers include display tabs that extend above the file folders and label the sections of the storage container but do not provide fixed dividers that define the size of the compartment. Therefore, a need exists for a file organizer that includes file dividers that can be accurately positioned within the opening interior of the storage body to define compartments for the hanging file folders.

### SUMMARY OF THE INVENTION

The present invention relates to an enclosed, self-contained file organizer for receiving a series of hanging file folders. The self-contained file organizer includes a series of dividers that can be selectively positioned within the file organizer to define labeled compartments for the hanging file folders.

The self-contained file organizer includes a storage body that has an outer wall and a bottom wall joined to each other to define an open storage cavity. The outer wall defines a file support edge that receives and supports hanging file folders such that the file folders are suspended within the open cavity of the file organizer.

The file organizer further includes a peripheral flange that is joined to the outer wall of the storage body and extends around the entire peripheral edge of the storage body. The peripheral flange defines a receiving cavity between the peripheral flange and the outer wall of the storage body.

A first series of alignment tabs are formed in the receiving cavity defined between the peripheral flange and the outer wall of the storage body. Each of the alignment tabs are spaced from each other by a constant distance to define discrete positions along the lateral length of the sidewalls of the storage body.

In addition to the first series of alignment tabs formed in the receiving cavity, the storage body includes a second series of alignment tabs formed between the bottom wall of the storage body and one of the sidewalls. The second series of alignment tabs are each spaced from each other by a constant distance that is the same as the distance between the first series of alignment tabs.

The file organizer further includes a series of individual file dividers that can be selectively positioned within the open storage cavity defined by the storage body to create multiple compartments within the open storage cavity. Each of the file dividers includes a main body portion and a pair of ears extending laterally from the main body portion. In addition to the pair of ears extending from the main body portion, each of the file dividers also include a pair of feet extending from the bottom edge of the file divider.

When each of the file dividers is positioned within the open cavity, the ears formed as part of the file dividers are positioned between a pair of the first series of alignment tabs formed in the receiving cavity. At the same time, the feet extending from the bottom edge of the file divider are each positioned between a pair of the second series of alignment tabs such that the first and second series of alignment tabs retain the dividers within selected positions within the storage cavity.

When the file dividers are positioned within the open storage cavity, hanging file folders can still be supported along the file support edge and can be moved along the file support edge between a pair of the stationary file dividers.

The file organizer includes a lid that is receivable on the peripheral flange extending from the outer wall of the main body. The peripheral flange includes a locking rib that engages the lid to hold the lid securely on the storage body.

### BRIEF DESCRIPTION OF THE DRAWINGS

The drawings illustrate the best mode presently contemplated of carrying out the invention. In the drawings:

FIG. 1 is a perspective view illustrating a file organizer having a lid with the lid removed;

FIG. 2 is an exploded view of the file organizer illustrating the file dividers positionable within the storage body;

FIG. 3 is a section view taken along line 3-3 of FIG. 1;

FIG. 4 is a section view taken along line 4-4 of FIG. 3; and

FIG. 5 is a section view taken along line 5-5 of FIG. 3.

### DETAILED DESCRIPTION OF THE INVENTION

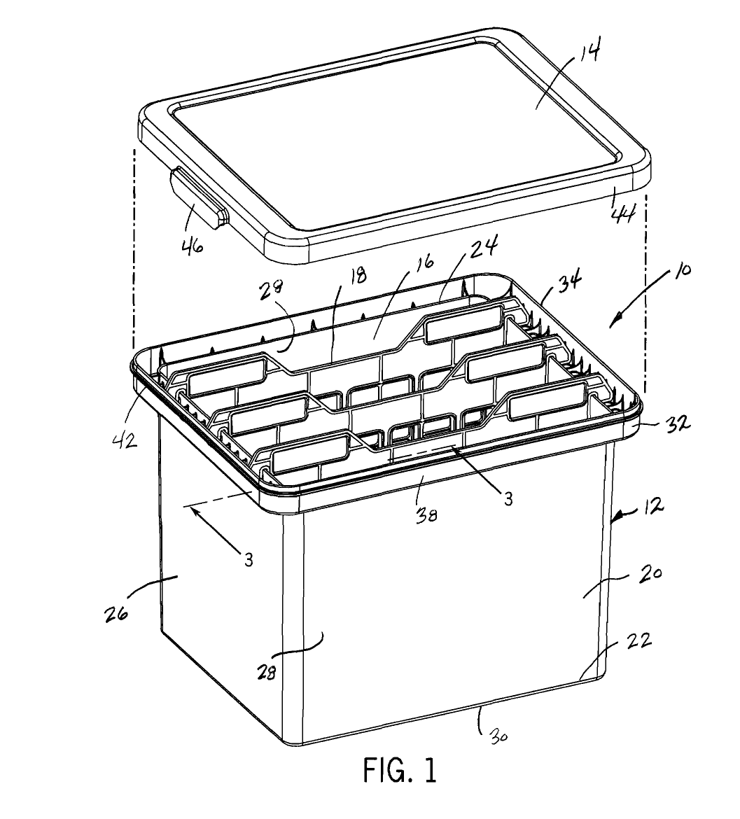

FIG. 1 illustrates a file organizer 10 that can be used to enclose and hold a series of hanging file folders for storage of records and other information. The file organizer 10 includes a storage body 12 and a lid 14 that can be received on the storage body 12 for enclosing an open storage cavity 16. The file organizer 10 includes a series of file dividers 18 that are selectively positionable within the storage cavity 16 to divide the storage cavity 16 into various different compartments for containing records and files relating to different categories. Each of the file dividers 18 is selectively positionable within the storage cavity 16 by a user to vary the size of the different compartments defined in the open interior by the series of file dividers 18.

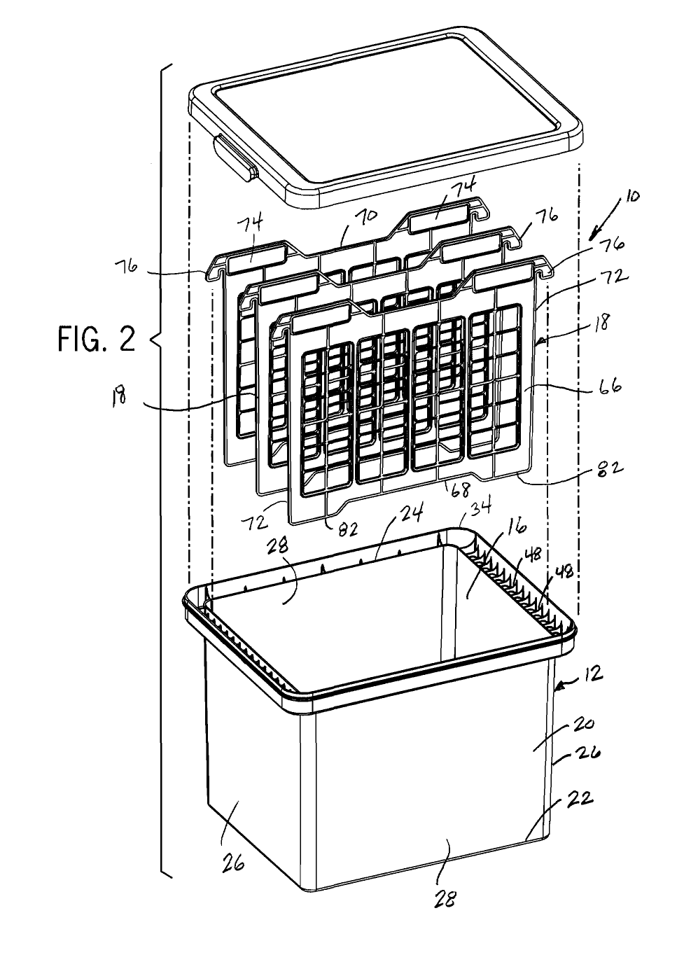

The storage body 12 includes an outer wall 20 that extends from a lower end 22 to an upper end defined by a file support edge 24. As illustrated in FIGS. 1 and 2, the file support edge 24 defines the top peripheral edge of the storage body 12 and thus defines the access opening to the open storage cavity 16. In the embodiment shown in FIGS. 1 and 2, the outer wall 20 that defines the generally rectangular open cavity 16 includes a pair of sidewalls 26 and a pair of end walls 28. The outer wall 20, which includes the pair of sidewalls 26 and the end walls 28, is joined to the peripheral edge of a bottom wall 30 which generally defines the base of the storage body 12. In the preferred embodiment of the storage body 12, the entire storage body 12, including the outer wall 20 and the bottom wall 30 are integrally formed with each other from a plastic material.

Referring back to FIG. 1, the file organizer 10 further includes a peripheral flange 32 that extends around the entire periphery of the outer wall 20. The peripheral flange 32 is joined to the outer wall 20 and defines a top edge 34 that is spaced laterally outward and upward from the file support edge 24 formed by the outer wall 20.

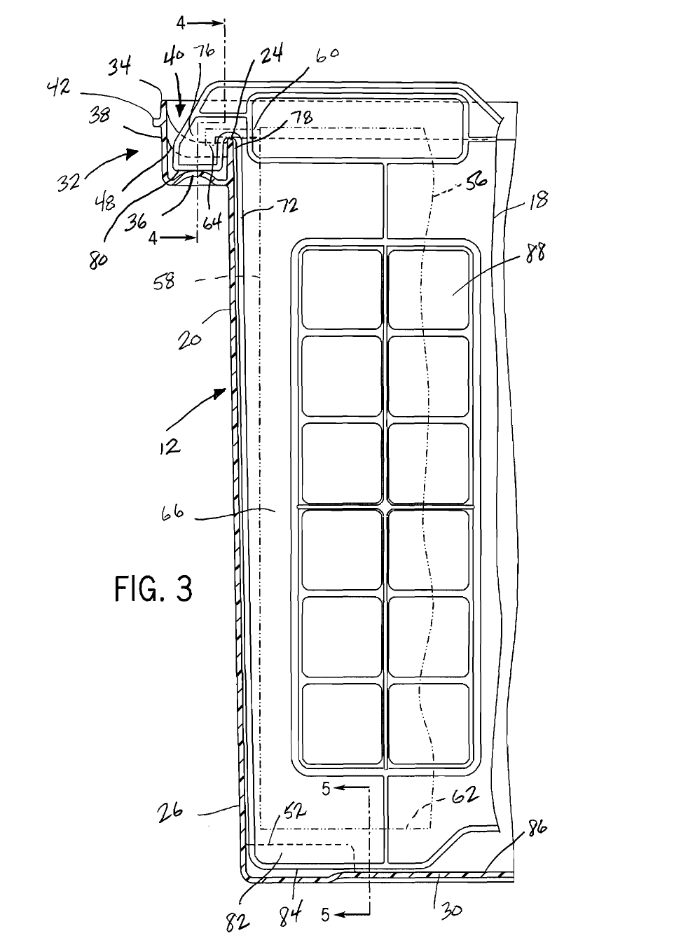

As can best be seen in FIG. 3, the peripheral flange 32 includes a base wall 36 and a sidewall 38. As illustrated in FIG. 3, the base wall 36 extends generally perpendicular to the outer wall 20 of the storage body 12. The sidewall 38 extends perpendicular to the base wall 36 and generally parallel to the outer wall 20. As illustrated in FIG. 3, the combination of the base wall 36 and the sidewall 38 defines a receiving cavity 40 between the outer wall 20 of the storage body 12 and the sidewall 38 of the peripheral flange 32.

As best shown in FIG. 3, the top edge 34 of the peripheral flange 32 extends above the file support edge 24 such that when the lid 14 is mounted to the storage body 12, the lid 14 contacts the top edge 34 and is spaced above the file support edge 24.

The sidewall 38 further includes a locking rib 42 that protrudes from the sidewall 38, as shown in FIGS. 1 and 3. As shown in FIG. 1, the lid 14 includes an outer wall 44 that engages the locking rib 42 to secure the lid 14 to the top of the storage body 12. The lid 14 includes a pair of handles 46 that aid in both carrying the entire file organizer 10 and in removing the lid 14 from the storage body 12.

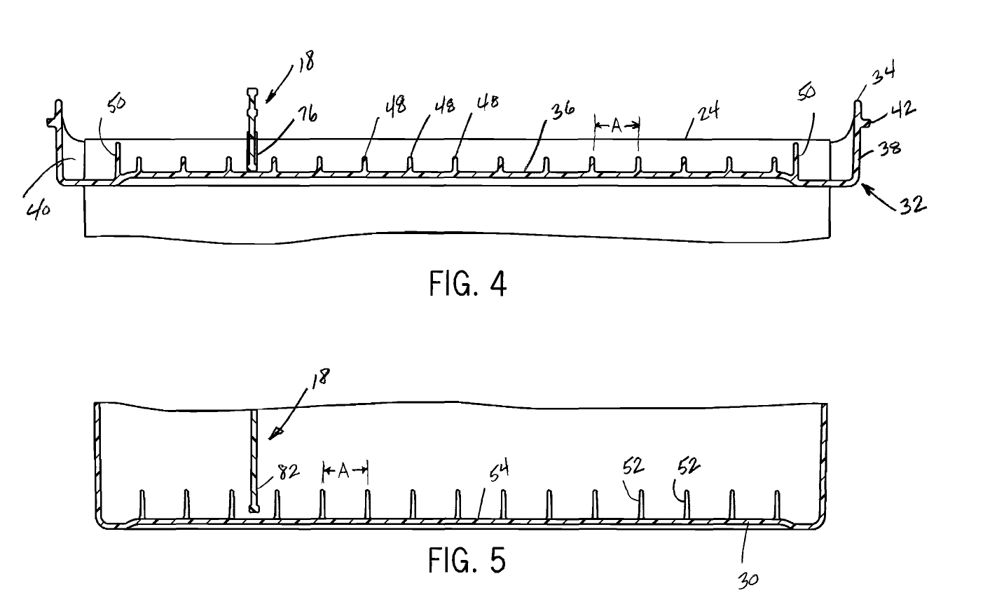

Referring back to FIG. 3, the file organizer 10 includes a first series of spaced alignment tabs 48 that each extend between the sidewall 38 of the peripheral flange 32 and the outer wall 20 of the storage body 12. As best illustrated in FIG. 4, the peripheral flange 32 includes a series of the alignment tabs 48 that each protrude above the base wall 36 and are spaced from each other by a constant distance A. The series of alignment tabs 48 extend along the entire length of each of the sidewalls 26 (FIG. 1) and include a pair of extended end tabs 50. The spacing between the series of alignment tabs 48 formed along one of the sidewalls 26 correspond directly to spacing between the same series of alignment tabs 48 formed along the opposite sidewall 26.

Referring now to FIGS. 3 and 5, the bottom wall 30 of the storage body 12 includes a second series of alignment tabs 52 that protrude from the inner face surface 54 of the bottom wall 30. As with the first series of alignment tabs 48 shown in FIG. 4, the second series of alignment tabs 52 are also spaced by a consistent distance A. Although only the alignment tabs 52 positioned between one of the sidewalls 26 and the bottom wall 30 are shown in FIGS. 3 and 5, similar alignment tabs 52 are positioned between the opposite sidewall 26 and the bottom wall 30. Thus, the spacing between the alignment tabs 48 formed in the receiving cavity of the peripheral flange directly correspond to the position and spacing between the second series of alignment tabs 52 that protrude from the bottom wall 30.

As illustrated in FIG. 3, each of the alignment tabs 52 protrudes from the bottom wall 30 and is joined to the sidewall 26. As shown in FIG. 3, each of the alignment tabs 52 extends only a short distance from the sidewall 26 such that the inner surface of the bottom wall 30 is generally smooth other than near the sidewalls 26.

FIG. 3 illustrates the position of a hanging file folder 56 within the open cavity defined by the storage body 12. The file folder 56 includes a main body 58 and a hanging rod 60. The rod 60 extends across the width of the storage cavity and rests upon the file support edge 24. In this manner, the storage body 12 is able to support a series of hanging file folders 56 such that the bottom edge 62 of the conventionally sized file folder 56 is supported slightly above the second series of alignment tabs 54 formed on the bottom wall 30. As illustrated in FIG. 3, the lowermost portion 64 of the hanging rod 60 is above the alignment tabs 48 such that the file folders 56 can slide along the length of the file support edge 24.

Referring now to FIG. 2, the file organizer 10 includes a series of file dividers 18 that are each selectively positionable within the open storage cavity 16 to divide the storage cavity into a series of individual compartments. As illustrated in FIG. 1, each of the file dividers 18 can be positioned at a selected location along the length of each of the sidewalls 26 to create compartments each having a user selectable size. Although three file dividers 18 are shown in the embodiment of the Figures, it should be understood that a different number of file dividers 18 could be utilized depending upon the size and number of compartments desired within the open storage cavity 16.

Referring now to FIG. 2, each of the file dividers 18 includes a main body portion 66 that extends generally from a bottom edge 68 to a top edge 70 and between a pair of spaced side edges 72. Each of the file dividers 18 includes a pair of display tabs 74 that extend above the top edge 70. Each of the display tabs 74 is sized to permit a label to be applied to the file divider 18 to describe the compartment created by the individual file divider 18.

Each of the file dividers 18 includes a pair of ears 76 that extends laterally from the side edge 72. As can best be seen in FIG. 3, each of the ears 76 is spaced from the side edge 72 of the main body portion 66 by a support cavity 78. The support cavity 78 extends upward past the lower edge 80 of the ear 76 such that the file support edge 24 contacts the file divider within the support cavity 78 to support the file divider within the open interior 16.

As can be understood in FIG. 3, the lower edge 80 of each of the ears 76 extends into the receiving cavity 74 past the top edge of the alignment tabs 48. Since each of the ears 76 extends past the edge surface of the alignment tabs 48, the alignment tabs 48 limit the lateral sliding movement of each of the file dividers 18 along the length of the file support edge 24. In this manner, the series of alignment tabs 48 retain the file dividers in a desired location within the open interior 16 of the storage body 12.

Referring back to FIG. 2, each of the file dividers 18 further includes a pair of feet 82 that extend below the bottom edge 68 of the file divider 18. As can best be seen in FIG. 3, each of the feet 82 extends downward past the top surface of the alignment tabs 52 such that the series of spaced alignment tabs 52 interact with the feet 82 to restrict the lateral movement of the file divider 18 within the storage cavity 16 of the storage body 12. As illustrated in FIG. 3, the bottom edge 84 of each of the feet 82 is spaced slightly above the inner surface 86 of the bottom wall 30 such that the file dividers hang within the open storage cavity of the storage body.

In the embodiment of the file dividers shown in FIGS. 2 and 3, the main body portion 66 includes a series of grids 88. The grids 88 are removed sections of the main body portion that reduce the amount of material required to form each of the dividers 16, which reduces the weight and cost of manufacturing the file dividers 18.

Referring now to FIGS. 4 and 5, when one of the file dividers 18 is positioned within the storage cavity, the ear 76 of the file divider 18 is positioned between a pair of the alignment tabs 48 (FIG. 4). At the same time, the feet 82 formed on the file divider 18 extend toward the bottom wall 30 and are positioned between a pair of the second series of alignment tabs 52 that extend from the bottom wall 30 (FIG. 5). As can be understood in FIGS. 4 and 5, the first series of alignment tabs 48 and the second series of alignment tabs 52 are aligned with each other such that the alignment tabs 48 and 52combine to prevent the sliding movement of the file divider 18 along the length of the file support edge 24 (FIG. 4). If the user desires to change the position of the file divider 18, the user must first lift the file divider from within the storage cavity until the ears 76 and feet 82 are above the respective alignment tabs 48, 52. Once the file divider has been lifted enough to remove the ears 76 from the receiving cavity 40, the file divider 18 can be moved laterally along the series of alignment tabs 48, 52 until the file divider is in the desired location. Once in the desired location, the file divider can be lowered such that the ears 76 and feet 82 are retained between the spaced alignment tabs 48, 52.

Although the file dividers 18 shown in the Figures include grids 88 and display tabs 74, it is contemplated that the file dividers 18 could take different shapes and forms while operating within the scope of the present invention.

I claim:

1. An enclosed, self-contained file organizer, comprising:
a storage body having an outer wall and a bottom wall joined to the outer wall to define an open storage cavity, wherein the outer wall extends from the bottom wall to a file support edge;
a peripheral flange joined to the outer wall of the storage body and extending around the storage body to define a receiving cavity between the peripheral flange and the outer wall;
a plurality of file dividers each positionable within the open storage cavity, each of the file dividers having a main body portion and a pair of ears extending laterally from the main body portion, wherein each of the ears are received within the receiving cavity when the file divider is positioned within the open storage cavity; and
a lid receivable on the storage body to enclose the open storage cavity.

2. The file organizer of claim 1 wherein each file divider includes a pair of support cavities positioned between one of the ears and the main body, wherein each support cavity receives the file support edge of the storage body.

3. The file organizer of claim 1 wherein the peripheral flange includes a base wall and a sidewall, wherein the base wall extends generally perpendicular to the outer wall of the storage body to space the sidewall from the outer wall of the storage body to define the receiving cavity.

4. The file organizer of claim 3 wherein the sidewall of the peripheral flange includes a locking rib engageable by the lid to secure the lid to the storage body.

5. The file organizer of claim 4 wherein the sidewall of the peripheral flange extends above the file support edge of the storage body such that the lid is spaced above the file support edge.

6. The file organizer of claim 2 wherein each of the file dividers includes at least one display tab extending above the support cavity.

7. The file organizer of claim 2 wherein each file divider includes a pair of feet extending from the main body, each of the feet being spaced slightly above the bottom wall of the storage body when the support cavity receives the file support edge.

8. An enclosable, self-contained file organizer, comprising:
a storage body having an outer wall and a bottom wall joined to the outer wall to define an open storage cavity, wherein the outer wall extends from the bottom wall to a file support edge;
a peripheral flange joined to the storage body and extending around the storage body to define a receiving cavity between the peripheral flange and the outer wall, at least a portion of the receiving cavity including a first series of spaced alignment tabs;
a plurality of file dividers each positionable within the open storage cavity, each of the file dividers having a main body portion and a pair of ears extending laterally from the main body portion, wherein each of the ears are received between a pair of the alignment tabs within the receiving cavity; and
a lid receivable on the storage body to enclose the open storage cavity.

9. The file organizer of claim 8 wherein the bottom wall of the storage body includes a second series of spaced alignment tabs extending from the bottom wall.

10. The file organizer of claim 9 wherein the spacing between the first series of alignment tabs generally corresponds to the spacing between the second series of alignment tabs.

11. The file organizer of claim 10 wherein each file divider includes a pair of feet extending from the main body such that when the file divider is positioned within the open storage cavity, the pair of ears are each received between a pair of the first series of alignment tabs and the pair of feet are each received between a pair of the second series of alignment tabs to restrict the movement of the file divider within the open storage cavity.

12. The file organizer of claim 9 wherein the outer wall of the storage body includes a pair of sidewalls and a pair of end walls, wherein the first series of alignment tabs are each joined to one of the sidewalls and the second series of alignment tabs are each joined to one of the sidewalls.

13. The file organizer of claim 8 wherein each file divider includes a pair of support cavities positioned between one of the ears and the main body, wherein each support cavity receives the file support edge of the storage body.

14. The file organizer of claim 8 wherein the peripheral flange includes a base wall and a sidewall, wherein the base wall extends generally perpendicular to the outer wall of the storage body to space the sidewall from the outer wall of the storage body to define the receiving cavity.

15. The file organizer of claim 14 wherein each of the alignment tabs extends from the base wall of the peripheral flange.

16. The file organizer of claim 14 wherein the sidewall of the peripheral flange includes a locking rib engageable by the lid to secure the lid to the storage body.

17. The file organizer of claim 16 wherein the sidewall of the peripheral flange extends above the file support edge of the storage body such that the lid is spaced above the file support edge.

18. The file organizer of claim 14 wherein each of the file dividers includes at least one display tab extending above the support cavity.
